(19) United States
(12) Patent Application Publication
(10) Pub. No.: US 2017/0215456 A1
(43) Pub. Date: Aug. 3, 2017

(54) SYSTEM FOR PREPARING CHILLED OR FROZEN PRODUCTS

(71) Applicant: NESTEC S.A., Vevey (CH)

(72) Inventors: André NOTH, Pully (CH); Fabien Ludovic AGON, Blonay (CH); Fanny CHEVET-DOUELLE, Bern (CH); Niels STOFFERS, Biglen (CH); Jean-Francois POTIGNON, Belfaux (CH); Pierre-Anton AICHINGER, Gümlingen (CH); Alexia DELAS, Beauvais (FR)

(73) Assignee: NESTEC S.A., Vevey (CH)

(21) Appl. No.: 15/330,788

(22) PCT Filed: May 6, 2015
(86) PCT No.: PCT/EP2015/059930

§ 371 Date: Nov. 7, 2016

(30) Foreign Application Priority Data
May 7, 2014 (GB) 14167344.2

(51) Int. Cl. A23G 9/28; A23G 9/12; B65D 85/804

(52) U.S. Cl. CPC A23G 9/283; B65D 85/804; A23G 9/12

(57) ABSTRACT

A single-use dispensing container (10) designed for being inserted into a device (20) where chilled and/or frozen products are prepared in a processing container (30), the dispensing container (10) comprising a plurality of ingredient compartments (10a) each comprising at least one ingredient for the preparation of the chilled or frozen product, wherein the dispensing container (10) comprises identification means providing the device (20) with information of the parameters for dispensing, cooling, texturizing and mixing the ingredients of the plurality of ingredient compartments (10a), such that the ingredients from the plurality of ingredient compartments (10a) are dispensed directly into the processing container (30), the dispensing of the ingredients being done either sequentially or simultaneously for the plurality of ingredient compartments (10a), as a function of the chilled or frozen product targeted.

### FIELD OF THE INVENTION

The present invention is directed to a system for preparing a plurality of chilled or frozen products such as ice-cream, milkshakes, sorbets, frozen or whipped yoghurt or the like. In particular, the invention is directed to an automated system for preparing a plurality of chilled or frozen products, these products having improved quality and improved visual, texture and taste contrasts.

### BACKGROUND OF THE INVENTION

Currently, the large majority of texturized chilled or frozen products such as ice-cream, milkshakes, sorbets, frozen yoghurt, whipped yoghurt or the like, that are consumed at home are products already bought chilled or frozen at the selling point, thus being later consumed without the need of any additional preparation. However, these products have several drawbacks associated, among others:
these products must be transported at their corresponding chilled or frozen temperatures, which is not only costly but that also impacts the product quality because of temperature fluctuations during transport and unload;
the formulation of these products must be provided with specific ingredients that make the texturized products be stable during their shelf life, which is costly and also impacts the product quality and taste; and
at the shelf point, these products have to be stored in a fridge or freezer which imposes that only a limited number of flavors is available considering standard fridge or freezer volumes.

Currently, a known alternative solution is the use of machines, such as blender, yoghourt maker or ice-cream maker to produce fresh products of the type referred to above. While the quality of the product obtained is good, the procedure is annoying and time-consuming due to the excessive number of manipulations required with the ingredients: all the ingredients must be weighed precisely and must be put in the fridge prior to their preparation to provide them with a specific temperature; the ingredients must be mixed previously and the production volume of such machines corresponds to several serving portions, all of the same flavor. The whole procedure with these machines requires about 30 minutes and besides, as the ingredients come into contact with a large number of parts of the machine (stirrer, tank, dispenser, etc.) there exists the need of cleaning all these parts as well.

Accordingly, other solutions have been provided to allow the preparation of texturized frozen products in a reduced amount of time, departing from liquid initial ingredients at ambient temperature. An example is provided in EP 12190562.4 belonging to the same applicant, where a system allowing the preparation of fresh frozen products in a reduced time of around 5 minutes is described: the system in EP 12190562.4 comprises a device and a disposable container; the container comprises the liquid ingredients at ambient temperature to prepare the final product, and can also contain a disposable stirrer as an integral part. The preparation process encompasses cooling and mixing, as well as air incorporation, with the product staying in the original container. At the end of the preparation process, the final fresh product is ready to be enjoyed in the original container with the stirrer used as a spoon: this process is fully clean thanks to the fact that the product is never leaving the container, so it never touches the machine.

However, further improvements could be envisaged in the system described in EP 12190562.4, as will be further described.
The system operates with one single chamber (that of the container) where simultaneous mixing and cooling takes place: however, for some products, it would be desirable to separate initial ingredients during their long storage at ambient temperature and only mix them before the preparation, to prevent protein aggregation and maximize foaming properties.
Because the system of EP 12190562.4 operates with one single chamber, the possibility to automatically make products with different color contrasts and textures can be limited.
Because the packaging containing the ingredients in the system of EP 12190562.4 is used as initial and final packaging, for products aimed at being foamed, the original container must have a large headspace (empty zone on the top of the un-foamed product) which means that the container is only partially-filled to allow the later increase in volume at processing, resulting in a larger volume of packaging needed.

It is known in the state of the art, as per WO 2013/121421 A1, a system for the preparation of cooled edible products where a receptacle comprising at least some of the ingredients for the final product is introduced in the system, these ingredients being later mixed and pre-cooled in a mixing chamber. This mixture is then allowed into a cooling chamber once a valve communicating the mixing and cooling chambers opens. The system has a unique outlet configured for dispensing the cooled edible product, typically by a handle operated by the user. This system also allows the use of several receptacles, containing different ingredients, introduced in the system for the final product: however, the operation in such a case requires that all the ingredients are introduced in the mixing chamber, and then transferred to a cooling chamber for being later cooled in the cooling chamber, so that the mixture of the product is not efficient and the range of final products that can be provided by such a system is very limited. Moreover, this process results in a low amount of air incorporated in the final product, which therefore has an unsatisfying final texture and a lower quality. A system as the one described in WO 2013/121421 A1 does not allow product diversity such as for example creating a multi-layered product configuration, with different texture and/or flavor for the different layers. In case such a configuration would be aimed at, the user would have to operate the system container per container, controlling the dispensing of each of the layers desired. It is clear that such a processing is not efficient, it is time consuming and not attractive for the user.

The present invention comes to solve the above-described problems, as it will be further explained. The invention also aims at other objects and particularly the solution of other problems as will appear in the rest of the present description.

### SUMMARY OF THE INVENTION

The present invention provides a system for preparing a large diversity of chilled or frozen products such as ice-cream, milkshakes, sorbets, frozen yoghurt, whipped yoghurt or the like in an automated way, such that the products obtained have an improved quality and improved visual, texture and taste contrasts. Typically, chilled products are preferably served at a temperature between 4° C. and 6° C., whereas frozen products are served at a temperature below 0° C., preferably between −2° C. and −10° C.

According to a first aspect, the present invention relates to a system for preparing chilled and/or frozen products in a processing container, such that the supply of the ingredients for these products is done directly into the processing container, which allows a very efficient mixing of the ingredients and also allows to provide a very large diversity of final products. Moreover, the system of the invention highly aerates the final product, so it has a very satisfying, high quality, soft and creamy texture.

Another advantage of the system of the invention is that it operates with an initial packaging comprising different compartments for the different ingredients, in such a way that, as the initial ingredients are separated, their quality is preserved until they are processed. Moreover, the initial packaging comprising the ingredients is disposable, the system also operating with a preparation and serving container (hereafter also called: “processing container”) that is preferably reusable: the initial ingredients are dispensed from the initial packaging into the processing container only when they are processed. In this way, the product differentiation is broader and the instant mixing of specific ingredients allows the production of a freshly made product with greatly enhanced quality.

The system of the invention also operates in a completely automated and friendly-user way, with a very high efficiency and a low processing time, which makes it extremely attractive for the final user.

The packaging with which the system of the invention operates is designed with the most limited headspace, so that the product quality is improved and any degradation of ingredients is avoided. Furthermore, the packaging volume is efficiently designed for a lower volume of packaging waste, and for optimizing the overall storage volume.

In a second aspect, the invention relates to a single-use dispensing container designed for being inserted into a device where chilled and/or frozen products are prepared in a processing container, as defined in claim 1.

In a third aspect, the invention relates to a device for preparing chilled and/or frozen products by means of a single-use dispensing container, comprising a dispensing unit receiving the dispensing container, the dispensing unit dispensing the ingredients from the dispensing container directly into the processing container, further comprising a stirring unit designed to move a stirrer for texturizing and mixing the ingredients, and also comprising a cooling unit designed to cool the ingredients dispensed from the dispensing unit, as defined in claim 6.

In a fourth aspect, the invention relates to a method for preparing chilled or frozen products as defined in claim 13.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a schematic view of the system for preparing chilled or frozen products according to the present invention.

FIGS. 2a and 2b show different embodiments of the processing container in the system for preparing chilled or frozen products according to the present invention.

FIG. 3 shows a schematic view of a preferred embodiment of the holding and releasing mechanism in the system for preparing chilled or frozen products according to the present invention.

FIG. 4 shows a schematic view showing the possible movements of the stirrer within the processing container in the system for preparing chilled or frozen products according to the present invention.

FIG. 5 shows a schematic view showing temperature sensing means in the system for preparing chilled or frozen products according to the present invention.

FIGS. 6a and 6b show the weak seal opening solution of the processing container in the system for preparing chilled or frozen products according to the present invention.

FIGS. 7a to 7f show the solution of opening the processing container by using a puncher in the system for preparing chilled or frozen products according to the present invention.

FIGS. 8a to 8c show the breaking edge solution of opening the processing container in the system for preparing chilled or frozen products according to the present invention.

FIGS. 9a to 9d show the twist-off closure solution of opening the processing container in the system for preparing chilled or frozen products according to the present invention.

FIG. 10 shows one embodiment using a piston for dispensing the content of the ingredient compartments in the system for preparing chilled or frozen products according to the present invention.

FIGS. 11a to 11c show another embodiment using a moving roller for dispensing the content of the ingredient compartments in the system for preparing chilled or frozen products according to the present invention.

FIG. 12 shows a schematic arrangement of the ingredient compartments of the dispensing container in the system for preparing chilled or frozen products according to the present invention.

FIG. 13 shows schematically an example of different phases/stages in the method for preparing chilled or frozen products according to the present invention.

### DETAILED DESCRIPTION OF EXEMPLARY EMBODIMENTS

The system 100 of the present invention comprises a dispensing container 10 provided with identification means, which is disposable, comprising the initial ingredients for the preparation of the product, and a device 20 conducting the process to prepare the chilled or frozen product, the device 20 being designed in such a way that a processing container 30 can be releasable fitted in the device 20. The processing container 30, preferably reusable, comprises a heat exchange surface 30a made of a thermally conductive material: the chilled or frozen product is prepared and served in the processing container 30, which also preferably comprises identification means.

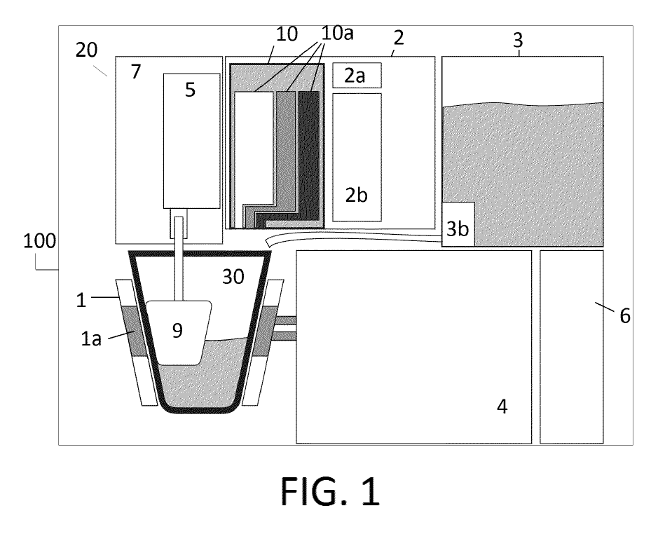

As shown in FIG. 1, the device 20 comprises a processing container receptacle 1, shaped to receive and hold the processing container 30: the processing container receptacle 1 is preferably made with a V-shape in order to maximize heat transfer with the processing container 30.

The device 20 also comprises a dispensing unit 2, where the dispensing container 10 is introduced, which dispenses the ingredients from the dispensing container 10 into the processing container 30. The dispensing unit 2 comprises a sensor 2a, which retrieves information from the identification means in the dispensing container 10, and a dispensing mechanism 2b, dispensing the ingredients from the dispensing container 10 directly into the processing container 30.

The device 20 of the invention also comprises a cooling unit 4 having a cooling element 1a, preferably an evaporator: the cooling element 1a serves as a heat exchanger, being the part of the cooling unit 4 that retrieves energy from the processing container 30, so the product inside the processing container 30 is cooled down. The cooling element 1a is designed to be adjacent to the heat exchange surface 30a of the processing container 30, when the processing container 30 is placed in the processing container receptacle 1 of the device 20; preferably, the cooling element 1a and the heat exchange surface 30a are complementary shaped. Moreover, the cooling element 1a is preferably arranged at an inner surface of the processing container receptacle 1. The cooling element 1a is preferably connected to or is integrally formed with the processing container receptacle 1.

The cooling element 1a is further of a material which provides excellent heat transfer properties, such as e.g. metal. Accordingly, the heat transfer between the processing container 30 and the cooling element 1a is significantly enhanced. As shown in FIG. 1, the processing container receptacle 1 is preferably only partially composed of the cooling element 1a. The rest of the processing container receptacle 1 is preferably formed of a material with a lower thermal heat capacity such as e.g. a polymer. According to such an embodiment, the thermal inertia and thus energy losses are reduced, which allows a faster cooling of the processing container 30.

The cooling unit 4 of the device 20 is adapted to cool the cooling element 1a. Since the cooling element 1a comprises excellent heat conductivity the processing container 30 (in particular the heat exchange surface 30a of the processing container 30 when being in touch with the cooling element 1a) is cooled. The cooling unit 4 can comprise any refrigeration and/or circulatory heat transfer system to cool the cooling element 1a, the heat exchange surface 30a and, consequently, the processing container 30, as quickly as possible.

The device 20 also comprises a stirring unit 5 moving a stirrer 9 in the processing container 30, the stirrer 9 being designed in such a way that it allows the simultaneous stirring and scrapping of the product in the processing container 30: the stirrer 9 can be made an integral part of the stirring unit 5 or, preferably, the stirrer 9 can be a disposable, a multiuse or a reusable element shaped as a spoon, a whisk or a spatula: if the stirrer 9 is shaped as a spoon, it is dispensed at the end of the process together with the processing container 30 for consuming the chilled or frozen final product. The stirrer 9 is designed in such a way that it incorporates air into the product and also moves the colder product from the processing container 30 walls that is in contact with the heat exchange surface 30a towards the centre of the processing container 30 to better equalize the product temperature.

The device 20 of the invention also comprises a control unit 6, which is in charge of the overall control of the automated process made by the device 20, as will be further explained in more detail.

Optionally, the device 20 comprises a defrosting system (not shown) in order to minimize the frosting of the cooling element 1a, on the heat exchange surface 30a, and/or on the processing container 30. The defrosting system is for example a hot gas defrost system that can comprise a switchable reversed compressor gas flow valve, a defrosting plate and/or a dry air circulation system with the humidified air. In a particular preferred embodiment, the defrosting system comprises a three-way valve being part of the cooling unit 4 designed to bypass a condenser thereof such that hot gases may be directly used for heating the cooling element 1a.

Also optionally, the device 20 of the invention can further comprise a liquid tank 3 for holding liquid such as e.g. water and a dedicated pump 3b. The liquid tank 3 is preferably connected to the dispensing mechanism 2b for providing liquid to the processing container 30 in case the specific product formulation so requires.

According to the invention, the device 20 preferably comprises a movable structure 7 into which the stirring unit 5 and optionally the dispensing unit 2 are mounted, the movable structure 7 being movable in rotation, translation, both, or any other movement, typically between an open position, allowing the insertion of the processing container 30 in the device 20, and a closed position, allowing the removal of the processing container 30 from the device 20. The movable structure 7 can be made to be partially of fully removed from the device 20.

The object of the device 20 of the invention is to obtain a chilled or frozen product having a creamy texture by freezing the product in the processing container 30 while the product is stirred by the stirrer 9. Furthermore, the product is obtained in very low time, in less than 5 minutes typically, using high-velocity stirring unit 5 and fast freezing cooling unit 4, the product having excellent properties and a creamy texture.

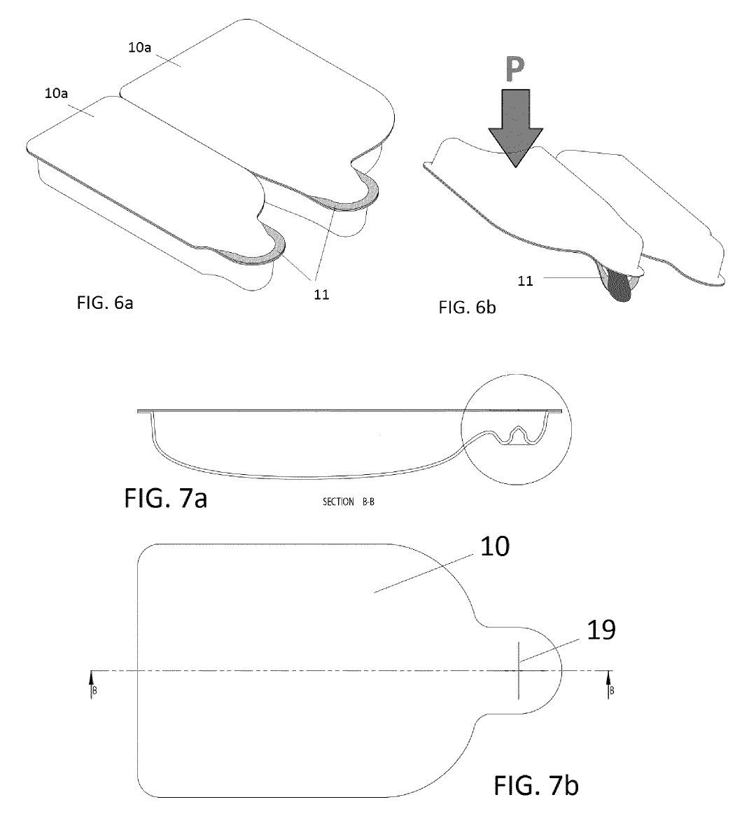

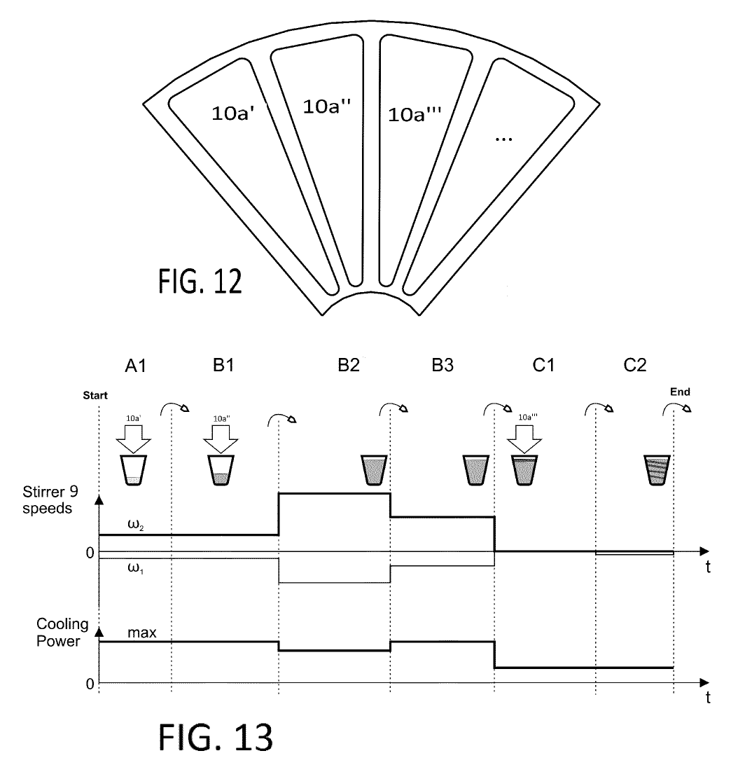

The dispensing container 10 comprises at least one ingredient compartment 10a with at least one ingredient for the preparation of the chilled or frozen final product. Typically, a plurality of ingredient compartments 10a′, 10a″, 10a′″, etc. (see FIG. 12) is provided, such that each compartment 10a comprises at least one ingredient or an ingredient composition. The dispensing container can be produced using various technologies, for example Blow-Fill-Seal or Thermoforming & Sealing: this latter possibility, resulting in a so-called Blister, is represented in FIGS. 6-9.

The ingredient compartments 10a comprise at least one or a mixture of ingredients selected from the following: whole milk, semi-skimmed milk, skimmed milk, cream, fermented milk, milk powder, milk whey proteins, gelatine, fruit preparation, fruit juice, fruit coulis, fruit puree, fruit puree concentrate, fruit juice concentrate, cereal material, sucrose, glucose, maltose, other complex carbohydrates such as maltodextrins, fructo-oligosaccharides, galacto-oligosaccharides, pectins, xanthan, guar, locust bean gum, cellulose, fibres material such as inulin, soy material, plant extracts material, chocolate material, coffee material, nuts splits material like hazelnuts, chestnuts, peanuts splits, flavours, mineral or vitamins material.

Moreover, the content of the ingredient compartments 10a is shelf stable under ambient conditions for an extensive period of time (e.g., several weeks): the ingredients in the ingredient compartments 10a are aseptically filled or hot filled in the case of acid/acidified food with a pH value of pH<4.5 and a water activity of a_{w}>0.85, and/or the ingredient compartments 10a are made gas-impermeable at ambient temperature, and/or the headspace in the ingredient compartment 10a comprises a protective inert gas such as CO₂, nitrogen or the like. By a shelf stable is meant products that do not spoil under ordinary unrefrigerated temperature and humidity conditions, if the package integrity is maintained. These products are free of microorganisms capable of growing in or on the product at non-refrigerated conditions at which the product is held during distribution and storage Food Safety and Inspection Service-United States Department of Agriculture (FSIS USDA 2005).

In a possible aspect, the ingredient container 10 comprises at least one primary ingredient compartment 10a′ comprising a first foaming composition, and at least one secondary ingredient compartment 10a″ comprising a second flavouring composition. For instance, the foaming composition comprises a milk base, i.e., a composition for which milk is the primary ingredient of the composition. Milk can be milk of animal such as cow or goat milk, or of vegetal origin such as soy material. Milk-free foaming ingredient can also be used such as chocolate-based material. The flavouring composition may comprise a natural flavouring composition such as a fruit base, i.e., a composition in which fruit is the primary ingredient (excepting water). The identification means of the ingredient container 10 contain information for a sequential dispensing in which the foaming composition is dispensed first for being at least partially texturized before the dispensing of the second composition.

Typically, at least one of the ingredient compartments 10a of the dispensing container 10 is deformable so as to allow the ingredient in it to be dispensed under compressive force exerted by the dispensing mechanism 2b. Moreover, each of the ingredient compartments 10a of the dispensing container 10 is designed in such a way that has the minimum headspace possible depending on the manufacturing process of the ingredient compartments 10a: typically, in the ingredient compartment 10a, the headspace volume compared to the volume occupied with ingredients is less than around 2%.

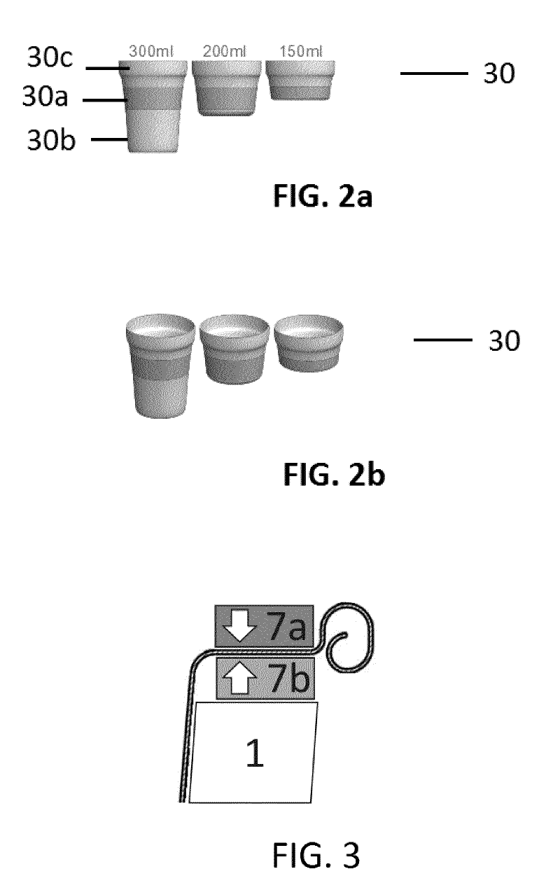

The system 100 of the invention is designed to operate with diverse dispensing containers 10 depending on the chilled or frozen product targeted: therefore, different processing containers 30 matching with the targeted product, therefore matching with the dispensing container 10, can be selected. FIGS. 2a and 2b show the different volumes of the processing container 30 having different volumes depending on the end product targeted, typically:
150 ml for light aerated dessert
200 ml for ice-cream
300 ml for milkshakes

The processing containers 30, even when having different volumes, all comprise the following parts: a heat exchange surface 30a, associated to the evaporator 1a for cooling the product inside the processing container 30; a scrapping surface 30b, the stirrer 9 being designed in such a way that allows scrapping the product held frozen inside the walls of the mentioned scrapping surface; and a top curl 30c, with a shape that prevents the product being spilled out of the processing container 30 during preparation of the targeted product.

Ideally, the processing container 30 is made of metal (steel, aluminum, etc.) in order to have an excellent thermal conductivity, particularly in the heat exchange surface 30a, but can also be made of a polymer or of a different material if the thickness of the walls in the processing container 30 and the drop of temperature wanted are small enough to ensure the cooling of the product in an acceptable time.

The processing container 30 is preferably reusable, but can also be made multi-use or disposable (single-use) in case the user wants to consume the chilled or frozen product somewhere else (“on the go”) and therefore has no need to clean the processing container 30 afterwards. In such a case, the heat exchange surface 30a is kept with a high thermal conductivity, but the top curl part 30c and/or the scrapping surface 30b are made of a material with a lower thermal conductivity for a more comfortable handling of the processing container by the user. The processing container 30 can also comprise at least one of the ingredients for the preparation of the chilled or frozen product.

As already explained, the dispensing container 10 comprises identification means in order to:
Allow the control unit 6 to adapt the process parameters to the recipe, according to the targeted product; and
allow the correct pairing of the dispensing container 10 and the processing container 30 so that the end product volume fits the processing container 30.

The identification means can comprise, for example, an optical bar code, radio-frequency identification means, embossing reading or any other suitable known means.

The processing container receptacle 1 has a shape such that its tightness with respect to the processing container 30 is improved: a conical or curved shape will be preferred to a cylindrical shape. Typically, if dimensions are not well controlled and considering the variation of temperature, a cylindrical shape could lead to a gap of air decreasing the heat transfer between the processing container 30 and the processing container receptacle 1, or even to the impossibility to insert the processing container 30 in the processing container receptacle 1. The conical or curved shape of the processing container receptacle 1 will ensure a perfect tightness and thus a very good heat transfer. The processing container receptacle 1 is partially made of a metallic material, which configures the evaporator 1a, the rest being made of a material with a lower thermal heat capacity, such as a polymer, therefore reducing thermal inertia and, consequently, the energy losses allowing a faster cooling of the final product.

The movable structure 7 can also comprise a holding and releasing mechanism which assures perfect contact tightness between the processing container 30 and the processing container receptacle 1 during the functioning of the system 100, whereas at the end of the process, it is required to remove this tightness so that the user can easily remove the processing container 30. Typically, as shown in FIG. 3, the holding and releasing mechanism comprises a holding ring 7a pressing the processing container 30 downwards into the processing container receptacle 1, and a releasing ring 7b, pressing the processing container 30 upwards the processing container receptacle 1. Consequently, as shown in FIG. 3, the shape of the processing container 30 is designed accordingly.

In the case that the stirrer 9 is not an integral part of the stirring unit 5, the stirrer 9 is preferably manually attached to the stirring unit 5; a system ensuring that the stirrer 9 stays in its position is also provided, for example using magnets or clips. At the end of the process, the stirrer 9 is automatically released in the prepared product.

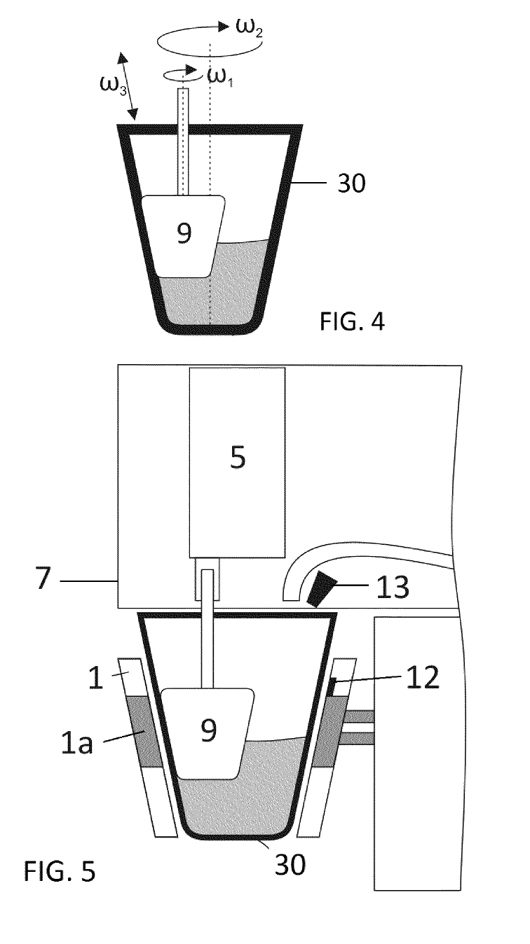

The stirrer 9 can follow a combination of the following movements, as shown schematically in FIG. 4, in order to best ensure the mixing and cooling of the product in the processing container 30, such that any of these movements can be either in clockwise or anticlockwise sense:
a rotation ω₁ around the axis of the stirrer 9
a rotation ω₂ around the axis of the processing container 30
optionally, a translation ω₃ parallel to the inside wall of the processing container 30.

During the process of preparing a chilled or frozen product in the system 100, the control unit 6 receives the following information input:
information on the type of product and the recipe from the identification means in the dispensing container 1, provided by the sensor 2a in the dispensing unit 2, and/or
an action triggered 7 commanded by the user, and/or
the processing time, entered for example by the user, and/or
information on the type of processing container 30, provided by the identification means in the processing container 30.

Also during the process of preparing a chilled or frozen product, the control unit 6 controls the following information provided by different dedicated sensors:
the temperature of the product, provided by an indirect temperature sensor 12 on the processing container receptacle 1 (typically a thermocouple, thermistor or a resistance temperature sensor) and/or by a direct temperature sensor 13 in the processing container 30 (typically an infrared temperature sensor heading towards the product in the processing container 30, as per EP 13190810.5), and/or
the torque provided by the motors (sensors provide the electrical current in the motors, the torque being proportional to the electrical current sensed) driving the stirrer 9 in such a way that the viscosity of the product in the processing container 30 is controlled, and/or
the overrun, providing the information on the aeration of the product in the processing container, i.e. the amount of air in the product.

The control unit 6 is designed in such a way that it adapts the process parameters to the information input received and to the information coming from the different sensors, as described above. Specifically, the process parameters adapted by the control unit 6 are: the stirring conditions (speeds and type of movements) of the stirrer 9 and the cooling power provided by the cooling unit 4. Optionally, in case the device 20 also comprises air injection means, the amount of air being injected would also be adapted by the control unit 6.

The dispensing container 10 is provided with a shape such that it can be inserted in the dispensing unit 2 only in one possible position and orientation; moreover, the dispensing container 10 comprises a dedicated opening to allow the device 20 to induce opening and dispensing of the dispensing container 10: for example, predetermined breaking points in the dispensing container 10 can be provided such that they are opened upon compression (passive way of opening) or via the mechanical handling of the dispensing container 10 (active way of opening). The breaking points have to be designed in such a way that they maintain during distribution, storage and handling the hermetic sealing of the dispensing container 10 (and therefore of the compartments 10a of it) and, at the same time, they need to allow an easy breakage once actuated by the dispensing mechanism 2b. The dispensing container 10 can have a pouch, bottle, blister, capsule type or any other design.

Prior to the dispensing of the content of any ingredient compartment 10a in the dispensing container 10, the ingredient compartment 10a has to be opened, for which several options are possible, as will be described herewith. In the examples below and in FIGS. 6-9, the dispensing container 10 has been represented as a blister.

Indirect Opening

The ingredient compartment 10a comprises a dedicated opening which is opened through squeezing with increased pressure during the dispensing process. As shown in FIGS. 6a-b, the dedicated opening can be a weak seal 11 in a defined section of the sealing area opening in a consistent way when a pressure threshold P is reached (see FIG. 6b).

Direct Opening

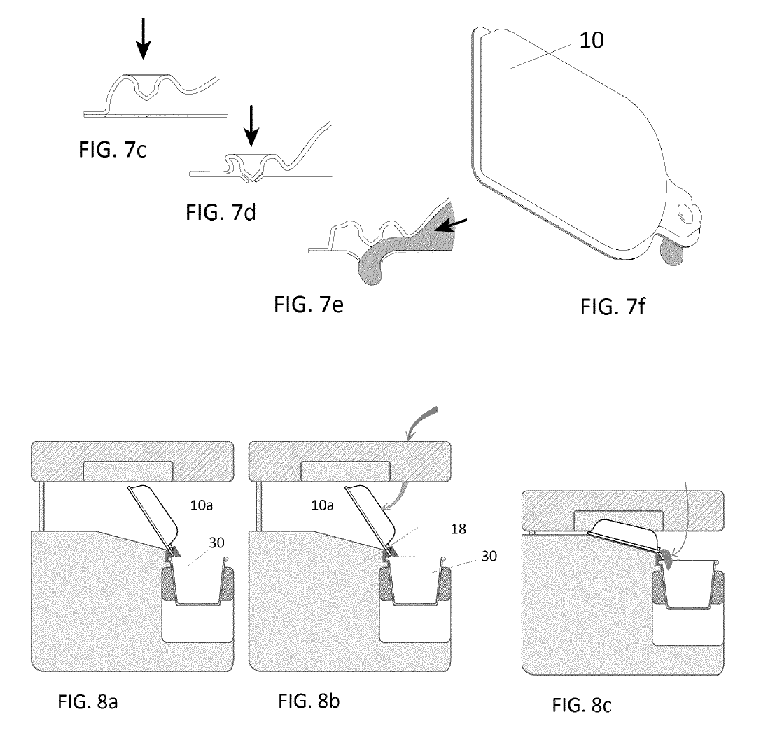

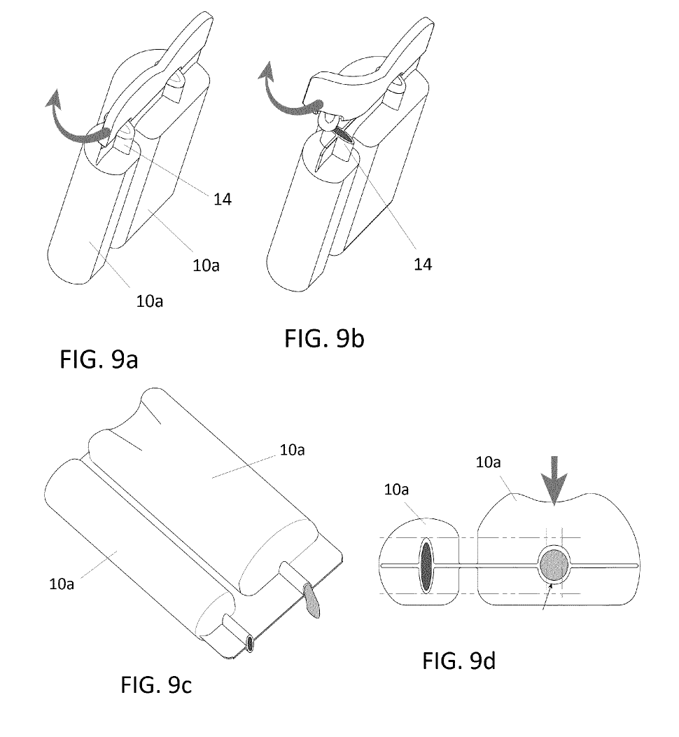

The opening of the ingredient compartment 10a is done actively and independently from the dispensing process, and it can be done in various ways.
Piercing, by means of compressing a dedicated opening 19 by a puncher, for example, that pierces the lid of the ingredient compartment 10a, possibly weakened by laser scoring, as shown in FIGS. 7a-f.
Breaking edge, as shown in FIGS. 8a-c, where the ingredient compartment 10a is bent to breaking along a predetermined bending line 18; when a plurality of ingredient compartments 10a exist, the plurality of the ingredient compartments 10a are opened at the same time, the folded part remaining attached to the main part (see FIG. 8c).
Twisting, as represented in FIGS. 9a-d, by using a dispensing container 10 comprising a plurality of ingredient compartments 10a based on blow fill seal technology, where the user removes an integrated twist-off closure 14 before inserting the dispensing container 10 in the device 20. Spillage will be avoided by designing the remaining opening in the container according to the viscosity of the product contained in it.

The dispensing mechanism 2b of the dispensing unit 2 can be configured for dispensing the content of the plurality of ingredient compartments 10a of the dispensing container 10 in various ways, preferably through the squeezing of the ingredient compartments 10a.

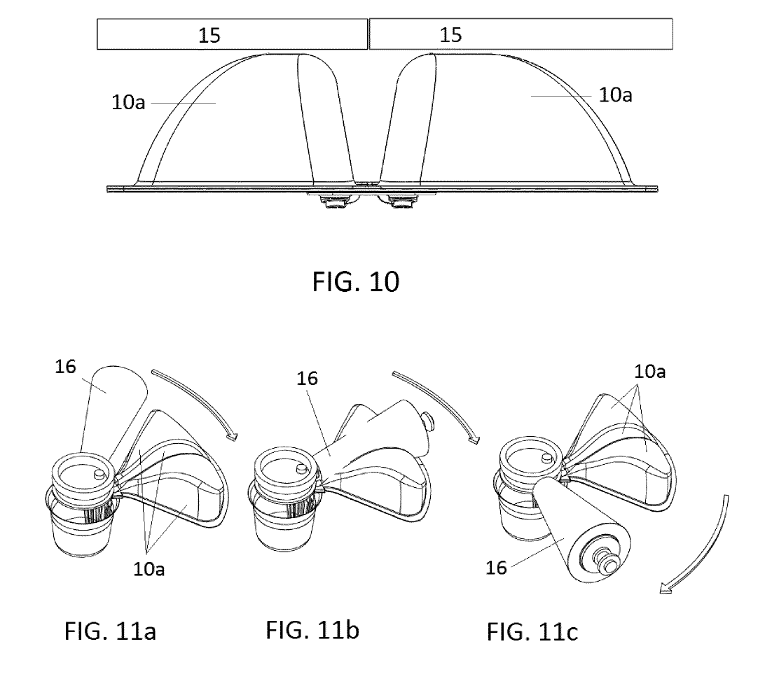

The dispensing mechanism 10b can comprise a piston 15, such as represented in FIG. 10: the piston 15 will then act on one or simultaneously on a plurality of ingredient compartments 10a; also, several pistons can be provided, having different sizes.

A preferred solution is that the dispensing mechanism comprises a moving roller 16 for squeezing the ingredient compartments 10a, such as represented in FIGS. 11a-c. This solution, compared to the piston solution, provides a much higher versatility: in fact, whereas the number and size of pistons are tightly linked to the number and size of the ingredient compartments 10a, the moving roller 16 is independent from the number and size of ingredient compartments 10a. The sequencing of dispensing, or the dispensing of at least two ingredient compartments 10a being done simultaneously, will only depend on the rotation angle of the moving roller 16.

In order to prevent that any of the compressed ingredient compartments 10a regains its initial shape, the ingredient compartments 10a are preferably closed after their content has been dispensed, particularly by sealing, which can be done through ultrasound or heat, for example. The final dispensing container 10 will therefore remain flat at the end of the process, with a lower volume of packaging waste.

The dispensing container 10 of the invention comprises identification means providing the control unit 6 with information of the parameters for dispensing, cooling, mixing and also for texturizing the ingredients of the plurality of ingredient compartments 10a, as a function of the chilled or frozen product targeted. Texturizing is typically obtained by whipping the mixture in the processing container 30 by the movements followed by the stirrer 9 and is also enhanced by the design of the stirrer 9. Optionally, the device 20 can also comprise air injection means (not shown) which are designed for the injection of air in the processing container 30, this aeration also contributing to the texturizing of the mixture in the processing container 30. However, the process followed in the system 100 of the invention is such that natural aeration of the product in a good level occurs so, typically, no further air needs to be injected, something that also makes that the final chilled or frozen product has a better perception to the user.

Also, the present invention is directed to a method for preparing chilled or frozen products in a processing container 30, departing from a dispensing container 10 and using the device 20, as will be described herewith in next paragraphs.

First, the user inserts an empty processing container 30 in the processing container receptacle 1, and attaches a stirrer 9 to the stirring unit 5 (in case the stirrer 9 is not already integrally provided with the stirring unit 5). Then, the user inserts a dispensing container 10 in the dispensing unit 2. For these operations the movable structure 7 must be held in the open position. Once the dispensing container 10 and the processing container 30 have been inserted in the device 20, the movable structure 7 moves to the closed position.

Then, the control unit 6 of the device 20 reads the identification means in the processing container 30 and in the dispensing container 10, checking that the processing container 30 the user has inserted in the processing container receptacle 1 is adequate with the dispensing container 10 inserted in the dispensing unit 2: when affirmative, the process starts; otherwise, a message is shown to the user in order to choose an adequate processing container 30.

Also according to the invention, the process can occur in different ways: the processing container 30 can be inserted, then the control unit 6 reads the information on the identification means in the processing container 30, later the dispensing container 10 is inserted, and the control unit 6 further reads the information on the identification means in the dispensing container 10. A later check of both informations is performed at the end. Any other possibilities are also covered by the invention.

After this, the sensor 2a of the dispensing unit 2 reads the information on the identification means in the dispensing container 10 (typically a bar code or similar) and sends this information to the control unit 6. The control unit 6 would also read any other information input, such as an action entered by the user or a time set in the device 20. The control unit 6 would then read the information of temperature of the product, viscosity and/or aeration from the reading of different dedicated sensors, and would adapt the process parameters accordingly (stirring conditions, cooling power and optionally, air injected).

The control unit 6 then commands (depending on the information read in the identification means in the dispensing container 10) the dispensing mechanism 2b to dispense the product of at least one of the compartments 10a into the processing container 30. According to the invention, also more than one compartment 10a can be dispensed simultaneously in the processing container 30.

Optionally, when any of the products dispensed in the processing container 30 is in a concentrated form, the control unit 6 will then command the pump 3b in the liquid tank 3 to add liquid into the processing container 30 in a certain quantity, determined by the identification means in the dispensing container 10: the liquid can be water, milk or any other type of liquid; optionally, the liquid can be added at hot temperature.

The control unit 6 controls that the stirring unit 5 adapts the movements and speeds of the stirrer 9, and that the cooling unit 4 adapts the cooling power of the cooling element 1a, according to the process parameters.

Depending on the recipe and the product aimed, the ingredient compartments 10a of the dispensing container 10 can be sequentially dispensed into the processing container 30, or at least two of the ingredient compartments 10a can be simultaneously dispensed into the processing container 30, the rest of the ingredient compartments 10a being sequentially dispensed. Further variations on the dispensing are also covered by the invention.

As schematically shown in FIG. 12, the initial ingredients for the chilled or frozen product are separated in different ingredient compartments 10a, which allows sequencing the ingredients during the method for preparing chilled and/or frozen products. From a sensory point of view, it is recommended to separate ingredients having different ranges of pH, of viscosity, etc., for example milk (neutral) and fruits (acid) or if you want to prevent flavors to be balanced together during the storage (other flavors will be generated, with less intense fruit flavor for example, or giving off flavors). For the viscosity aspect, if you store for example yoghurt with fruit puree, you will have to add thickeners to the fruit puree in order to prevent changes of viscosity with time due to water exchanges between the milk protein gel and the fruits; therefore, adding the ingredients in a sequential manner allows to simplify the recipes.

Additionally, instead of a method using constant process parameters, it is part of this invention to sequence the method into several phases/stages, during which different process parameters may be used, such that these process parameters may be constant or may be calculated as an interpolation between points. The transition between the phases/stages is triggered by the different values coming from different sensors (temperature sensors such as indirect temperature sensor 12, or direct temperature sensor 13, electrical current sensors on the motors driving the stirring unit 5), by time and/or by an action triggered by the user, such that these sensor values are received by the control unit 6, which then adapts the process parameters in the different phases/stages. The following two examples below illustrate the advantages of the method according to the invention.
Robustness to varying conditions: the device 20 of the invention is to be used by the user in very different conditions and should however deliver always a constant product. Starting the device 20 for the first time in the day or starting the 20^{th} ice-cream in a row, inserting a dispensing container 10 at 25° C. or at 35° C. are examples of such variations amongst many: the different sensor values received by the control unit 6 allow the adaptation of the method to all the different varying conditions.
Lower risk of splashes: for example, an ice-cream mix is very liquid at the beginning and the high speeds of the stirrer 9 very rapidly lead to splashes from the dispensing container 30. However, it is necessary when the product starts freezing in the dispensing container 30 to stir and scrap very rapidly to avoid the formation of thick crust and to obtain a very creamy texture. When the product is much more viscous at low temperatures, splashes are avoided. Therefore, it is necessary that the method of the invention adapts the speeds of the stirrer 9 during the process, such that this adaptation is done based on the values given by the different sensors (temperature sensors in this case).

Together with FIGS. 12 and 13, an example of a method for preparing an ice-cream according to the present invention, the method being sequenced in phases/stages, is described herewith. The dispensing container 10 comprises three ingredient compartments 10a: 10a′ comprising a dairy base (no fruit), 10a″ comprising a fruit purée, separated from the dairy base in 10a′ for flavor and color preservation and 10a′″ comprising fruit coulis, separated from 10a′ and 10a″ because it will be dispensed at the end of the process.

The method, represented on FIG. 13, comprises the following phases/stages:
Phase A1. The dairy base is dispensed from the ingredient compartment 10a′, the cooling unit 4 being turned on directly at maximum power and, simultaneously, the stirrer 9 moves at medium speed, under rotation ω₁ around the axis of the stirrer 9 and also under a rotation ω₂ around the axis of the processing container 30, the rotations ω₁ and ω₂ taking place in opposite senses (clockwise and anti-clockwise or the contrary) in order to avoid splashes, but still ensure an efficient heat transfer in the product. The next phase is triggered only when the ingredient compartment 10a′ has been emptied.
Phase B1. The fruit purée from the ingredient compartment 10a″ is dispensed, maintaining the same cooling and stirring conditions as in Phase A1. The next phase is triggered only when the ingredient compartment 10a″ has been emptied and when the temperature of the product in the processing container 30 is below 1° C.
Phase B2. Having reached 1° C., the product at this temperature is more viscous and higher speeds of the stirrer 9 do no more lead to splashes: therefore, the stirring speeds ω₁ and ω₂ of the stirrer 9 are increased to integrate a target amount of air (that is, for foaming/texturizing the product) during a predetermined amount of time (60 seconds in the example here), still keeping cooling at a medium level. The next phase is triggered after 60 seconds of texturizing/foaming.
Phase B3. The product having reached at this stage the target amount of air (overrun), the temperature of the product is now reduced with maximum cooling and medium speeds ω₁ and ω₂ of the stirrer 9, until a target viscosity is obtained. The next phase is triggered when the target viscosity of the product is reached, i.e., when the torque (proportional to the electrical current in the motors driving the stirrer 9) reaches 120 mNm.
Phase C1. The Ice-Cream is now at the target temperature, target viscosity, target texture and very homogeneous. To give a better product from the visual point of view, the fruit coulis in the ingredient compartment 10a′″ are now dispensed. The next phase is triggered only when the ingredient compartment 10a′″ has been emptied.
Phase C2. A limited number of turns of the stirrer 9 (six, in the example) are executed, to create a swirl for good visual appearance of the final product. The end of the process (recipe) is reached after the six turns of the stirrer 9.

The sequencing in phases/stages of the method of the invention may be different for each product targeted, and is thus:
either fully coded on the identification means in the dispensing container 10, which are read by the control unit 6, or
stored in the machine memory, and only referred to by a simple identification code on the identification means in the dispensing container 10.

Also, the number of phases/stages, the triggering events of the different phases/stages and all the values presented above are just given as examples, but can be modified at will. As well, the jump between phases can be done backwards and also forward; what is important is the global principle of changing from one phase to another by either reaching a certain threshold of a sensed physical value or after a certain time having elapsed or by an action from the user, or a combination of them.

Once the process has ended, the control unit 6 commands the opening of the movable structure 7, so that the user can release the processing container 30. The control unit 6 also commands the stirring unit 5 to release the stirrer 9 (in case the stirrer 9 is not integrally provided with the stirring unit 5), which can become a potential spoon.

As an example of product composition processed by the system 100 of the invention, a mango milkshake (chilled and foamed product) would be prepared from a primary ingredient compartment 10a′ of the dispensing container 10 containing a milk base consisting of an ambient preparation of plain milkshake, with a volume of 105 ml, comprising (the percentages are given in weight):
Skimmed milk: 66%
Milk cream 34% fat: 20%
Water: 12, 23%
Modified rice starch: 0, 4%
Skimmed milk powder: 0, 7%
HM pectin: 0, 6%
Starter culture: 0, 07%

The mango milkshake of the example would also be made from a secondary ingredient compartment 10a″ in the dispensing container 10 containing a fruity base consisting of pasteurized mango puree, with a volume of 140 ml, comprising:
Mango puree: 90%
Sucrose: 10%

In the above example of the mango milkshake, once the user has introduced in the device 20 the ingredient container 10, the dispensing unit 2 would then first dispense into the processing container 30 the content of the primary ingredient compartment 10a′, which would be processed under certain stirring conditions, time, temperature, viscosity, etc. according to the identification means in the ingredient container 10. Depending on the recipe, the dispensing unit would then dispense the content of the secondary ingredient compartment 10a″ into the processing container 30, where the mixture would be processed according to the information in the identification means in the ingredient container 10, until the final product is achieved. Depending on the recipe contained in the ingredient container 10, the dispensing unit 2 can also dispense the content of both primary and secondary ingredient compartments 10a′ and 10a″ simultaneously in the processing container 30. Any variation is also possible according to the information that is comprised in the ingredient container 10.

Typically, for the preparation of a frozen product with the device 20 of the invention, the composition in the processing container 30 is cooled for a period below 10 minutes to a temperature below 0° C., preferably to a temperature in the range from −2 to −10° C., and at the same time, the composition is aerated (i.e., air is incorporated into the mixture as it cools, such that more air is incorporated into the preparation as mixing time increases) to an overrun in the range from 30% to 120% by being stirred by the stirrer 9 and by contacting the composition during freezing with the stirrer 9. By a way of example, the stirrer 9 has a planetary movement with an angular velocity ω2 between 30 and 300 rpm and/or a rotation about an axis with an angular velocity ω1 between 1 to 1700 rpm, preferably between 400 and 900 rpm. A particular preferred optimum for the making of a frozen product is with a ω1 between 700 and 900 rpm.

Some of the main advantages of the system 100 of the present invention are the following:
separated initial ingredients for a better product quality;
none or very limited headspace for a better product quality;
more product differentiation through instant mixing of specific ingredients or preparations allowing a freshly made sensory experience;
the packaging volume is efficiently designed for a lower volume of packaging waste, and for optimizing the overall storage volume;
further reduction in preparation times of chilled or frozen products through the controlled continuous dispensing of product during the preparation period.

Additionally, as the initial ingredients are separated in multiple compartments, it is now possible to sequence their dispensing along time, depending on the recipe, which provides the following additional advantages:
improved product quality by applying cooling, foaming and texturizing process in steps to a partial number of initial ingredients, for example by foaming the milky base first and then adding fruity base, whereas foaming both bases together would have results in a lower amount of air incorporated, so the texture would be less good;
improved product visual and enhanced texture and taste contrasts by multi-layering dispensing, as the dosing and processing is done sequentially, as explained above; also, some final toppings or final ingredients can be added at the end of the process, coming from another ingredient compartment 10a, such as, for example, a fruit coulis that can be dispensed at the last minute: in this case, no processing is needed for such kind of ingredients and the stirrer 9 can either not do any movement or can only do limited movement (for example, with only two turns of the stirrer 9 a nice swirl on the top of the final product can be created).

Although the present invention has been described with reference to preferred embodiments thereof, many modifications and alternations may be made by a person having ordinary skill in the art without departing from the scope of this invention which is defined by the appended claims.

### LIST OF REFERENCES

100 System for preparing chilled or frozen products
   10 Dispensing container
      10a Ingredient compartment
      10b Dispensing mechanism
   20 Device for preparing chilled or frozen products
      1 Processing container receptacle
         12 Indirect temperature sensor
      2 Dispensing unit
         2a Sensor
         2b Dispensing mechanism
            11 Weak seal
            19 Dedicated opening
            18 Predetermined bending line
            14 Integrated twist-off closure
            15 Piston
            16 Moving roller
      3 Liquid tank
         3b Pump
      4 Cooling unit
         1a Cooling element
      5 Stirring unit
         9 Stirrer
      6 Control unit
      7 Movable structure
         7a Holding ring
         7b Releasing ring
   30 Processing container
      30a Heat exchange surface
      30b Scrapping surface
      30c Top curl
      13 Direct temperature sensor

1. A single-use dispensing container designed for being inserted into a device where chilled and/or frozen products are prepared in a processing container, the dispensing container comprising at least one ingredient compartment comprising at least one ingredient for the preparation of the chilled or frozen product, wherein the dispensing container comprises an identification means member providing the device with information of the parameters for dispensing, cooling, texturizing and mixing the ingredients of the at least one ingredient compartment, such that the ingredients from the at least one ingredient compartment are dispensed directly into the processing container, the dispensing of the ingredients being done either sequentially or simultaneously for the at least one ingredient compartment, as a function of the chilled or frozen product targeted.

2. A single-use dispensing container according to claim 1, wherein at least one of the ingredient compartments is deformable so as to allow the ingredient in it to be dispensed under compressive force exerted by the device, being further designed in such a way that its headspace volume is less than around 2%.

3. A single-use dispensing container according to claim 1, designed in such a way that it is inserted into the device only in one possible positioning and orientation, wherein the dispensing container comprises a dedicated opening allowing the device to induce opening and dispensing of its content.

4. A single-use dispensing container according to claim 1, wherein the at least one ingredient compartment comprises at least one ingredient selected from the group consisting of: whole milk, semi-skimmed milk, skimmed milk, cream, fermented milk, milk powder, milk whey proteins, gelatine, fruit preparation, fruit juice, fruit coulis, fruit puree, fruit puree concentrate, fruit juice concentrate, cereal material, sucrose, glucose, maltose, other complex carbohydrates, fiber material, chocolate material, coffee material, nuts splits material flavors, mineral and vitamins.

5. A single-use dispensing container according to claim 1, comprising at least one primary ingredient compartment comprising a first foaming composition, and at least one secondary ingredient compartment comprising a second flavoring composition, and wherein the identification means member of the dispensing container contains information for a sequential dispensing in which the foaming composition is dispensed first for being at least partially texturized before the dispensing of the second composition.

6. A device for preparing a chilled and/or frozen product by use of a single-use dispensing container, wherein the device comprises a dispensing unit designed to receive a dispensing container, the dispensing unit dispensing the ingredients from the dispensing container directly into a processing container, the device further comprising a stirring unit moving a stirrer for texturizing and mixing the ingredients, the device also comprising a cooling unit designed to cool the ingredients in the processing container, wherein the device also comprises a control unit which adapts the speeds and movements of the stirrer and/or the cooling power of the cooling unit to the information in the received by an identification means-member of the dispensing container.

7. A device according to claim 6, wherein the stirrer is designed to move following at least one or a combination of a movement selected from the group consisting of: a rotation around the axis of the stirrer, a rotation around the axis of the container of the chilled or frozen product, and a translation parallel to at least one of the walls of the container of the chilled or frozen product.

8. A device according to any of claim 6, wherein the dispensing unit comprises a sensor designed to retrieve the information from the identification member in the dispensing container and to send it to the control unit for the control of the dispensing, cooling, texturizing and mixing of the chilled or frozen product.

9. A device according to any of claim 6, comprising a processing container receptacle which is in cooling conductive contact with an evaporator, the evaporator being controlled by the cooling unit.

10. A device according to claim 9, designed in such a way that releasable fitting of the processing container in the processing container receptacle is allowed, such that the evaporator matches a heat exchange surface of the processing container once the processing container is introduced in the processing container receptacle, the heat exchange surface having a thickness and being made of a material allowing cooling of the product in the processing container in a certain time established by the control unit.

11. A device according to claim 6, comprising a moving roller designed for pressing the at least one ingredient compartment so that their content is dispensed.

12. A system comprising a device for preparing a chilled or frozen product comprising a dispensing unit designed to receive a dispensing container, the dispensing unit dispensing the ingredients from the dispensing container directly into a processing container, the device further comprising a stirring unit moving a stirrer for texturizing and mixing the ingredients, the device also comprising a cooling unit designed to cool the ingredients in the processing container, wherein the device also comprises a control unit which adapts the speeds and movements of the stirrer and/or the cooling power of the cooling unit to information received by an identification member of the dispensing container, and a single-use dispensing container the system being designed in such a way that the ingredients are directly dispensed from the single-use dispensing container into a processing container releasable fitting into the device.

13. Method for preparing using a device a chilled or frozen product from a single-use dispensing container, the single-use dispensing container comprising at least one ingredient compartment with at least one ingredient for the chilled or frozen product, the dispensing container also comprising the process parameters information for the preparation of the chilled or frozen product, wherein a dispensing unit of the device dispenses the content of the at least one ingredient compartment directly into a processing container, the method being such that the product in the processing container is cooled by a cooling unit of the device, the product being further mixed and texturized by a stirrer moving in the processing container, wherein the speeds and movements of the stirrer and the cooling power of the cooling unit are adapted by a control unit in the device to the process parameters information in the dispensing container.

14. Method according to claim 13, wherein the single-use dispensing container comprises a plurality of ingredient compartments, the method being such that the ingredient compartments are sequentially dispensed into the processing container, or such that at least two of the ingredient compartments are simultaneously dispensed into the processing container, the rest of the ingredient compartments being sequentially dispensed, as a function of the process parameters information in the dispensing container.

15. Method according to claim 13, wherein the method is sequenced into several phases during which different process parameters may be used, such that the transition between the phases is triggered by the values coming from different sensors, such as temperature, torque and/or overrun sensors, and/or by time, and/or by an action triggered by the user.
